(19) United States
(12) Patent Application Publication
(10) Pub. No.: US 2007/0246331 A1
(43) Pub. Date: Oct. 25, 2007

(54) Safety Switch

(76) Inventor: Andrea Bennetti, Oxfordshire (GB)

Correspondence Address: LAW OFFICES OF WILLIAM H. HOLT, 12311 HARBOR DRIVE, WOODBRIDGE, VA, 22192, US

(21) Appl. No.: 11/575,129

(22) PCT Filed: Sep. 6, 2005
(86) PCT No.: PCT/GB05/50142

§ 371 Date: May 4, 2007

(30) Foreign Application Priority Data
Sep. 10, 2004 (GB) 0420049.9

(51) Int. Cl. H01H 9/00

(52) U.S. Cl. 200/4

(57) ABSTRACT

A switch comprising: first and second fixed electrical contacts, first and second power source contacts, a handle, and two mobile conductors moveable axially simultaneously between a non-conducting position and a conducting position wherein in the conducting position one conductor contacts the first fixed electrical contact and the first power source contact and the other conductor contacts the second fixed electrical contact and the second power source contact and wherein subjecting the handle to both rotational and axial movement causes the mobile conductors to move between the non-conducting position and the conducting position, so activating the switch.

The present invention relates to a switch, in particular a safety switch which is particularly suitable for connecting a power source to an electrical circuit.

In many applications it is important to incorporate a safety switch in order to be able to disconnect a power source from an electrical circuit. This can be particularly important where a power source, such as a battery, provides high voltage or high current power to a manned vehicle or a part thereof in order to safeguard the operator.

Many safety switches are known such as those disclosed in U.S. Pat. No. 6,686,552 and U.S. Pat. No. 5,864,106. Typically, such switches move a single connector so as to open and close the electrical circuit. Once the circuit has been disconnected, the battery may be removed or the circuit may be adjusted or maintained in safety.

The present invention provides a switch which uses two conducting components in order to make the electrical connection. Thus when the switch is in the ‘off’ position the electrical circuit is broken at two points. This can lead to a more compact switch. In addition, a switch which makes two disconnections is typically safer as the power source can be disconnected from the electrical circuit at both poles. Thus, the electrical circuit is completely isolated from the power source. This greatly reduces the likelihood that an operator receives an electric shock when working on the electrical circuit. This can be very important in high voltage or high current situations. A double disconnection of this type can also be used to disconnect two power sources or two parallel power sources simultaneously, for example electric grid power and a backup battery. In a further embodiment the switch can be used to disconnect two separate electrical circuits simultaneously.

Accordingly, the present invention provides a switch comprising:

first and second fixed electrical contacts,

first and second power source contacts,

a handle, and

two mobile conductors moveable axially simultaneously between a non-conducting position and a conducting position wherein in the conducting position one conductor contacts the first fixed electrical contact and the first power source contact and the other conductor contacts the second fixed electrical contact and the second power source contact and wherein subjecting the handle to both rotational and axial movement causes the mobile conductors to move between the non-conducting position and the conducting position, so activating the switch.

When the mobile conductors are in the non-conducting position there is no conducting path from the fixed electrical contacts to the power source contacts.

The present invention also provides a portable power source comprising a switch of the present invention.

In general, the power source may be the electric grid or a self-contained power source which may be fixed or portable such as a battery, fuel cell or generator.

In one embodiment of the present invention, the two mobile conductors are located on a single axle or rod and are insulated from one another. In a preferred embodiment of the present invention, the mobile conductors are located on two rods or portions thereof which are connected together. The switch is typically a bipolar switch. However, in a further embodiment the switch may be multipolar. For example, the switch may be tripolar in which case there are three fixed electrical contacts, three power source contacts and three mobile conductors.

The conducting portions of the switch are generally made of metal. Preferred metals include steel, copper and gold. High conductivity copper is particularly preferred. For the mobile connectors it is preferred to use a conductor which is formed so as to ensure that a good electrical connection is achieved when the mobile conductor is in the conducting position. A preferred material is a metal component comprising rows of torsional springs which when pressed form a line contact which can slide axially. A particularly preferred material for such torsional spring conductors is an alloy of copper and beryllium plated with gold or silver. The torsional spring products sold as Multilam™ can be suitable for use as these connectors.

The fixed electrical contacts are typically separated from the power source contacts by an insulating material, typically a solid insulator.

A preferred material for insulating components of the switch is glass reinforced epoxy resin. However, any insulator able to withstand the operating conditions of the switch may be used. The switch is typically housed in an insulating casing which is also preferably made from glass reinforced epoxy resin.

The fixed electrical contacts may comprise plugs or sockets for connection to the rest of the electrical circuit. In a preferred embodiment of the present invention, the electrical contacts comprise sockets. Typically, the switch is an integral part of a power source containing a switch of the present invention and the power source contacts are housed within the power source. However, in one embodiment the switch is connected externally to the contacts of a power source for example by cables. In such an embodiment the power source contacts of the switch comprise connectors for connection to the power source.

The handle includes insulating portions to insulate the operator from the electrical circuit. In a preferred embodiment, the handle is so shaped as to cover the fixed electrical contacts when the conductors are in the conducting position. Rotational and axial movement of the handle is required to move the mobile conductors from the non-conducting position to the conducting position. Typically the same handle movement occurs in reverse in order to return the mobile conductors to the non-conducting position.

The handle may be biased to the non-conducting position or to the conducting position using a spring, for example a coiled spring.

The handle is connected to the conductors via a rotateable connection. This enables the handle to be rotated relative to the mobile conductors and their supports. For example, the rotating connection may be configured so as only to allow rotation of the handle when the mobile conductors are in the non-conducting position. If the handle is also shaped so as to cover the fixed electrical contacts, this combination of mechanisms only allows access to the fixed electrical contacts when the power source is disconnected from the electrical circuit.

The handle undergoes rotational and axial movement in order to move the mobile conductors between the non-conducting and conducting positions. For example, when the conductors are in the non-conducting position the handle is typically rotated and then moved axially to move the mobile conductors to the conducting position. To disconnect the conductors the same movements are made in reverse. By using both rotational and axial movement of the handle, the handle cannot be moved accidentally. The combination of rotational movement and axial movement of the handle also makes it possible to incorporate one or more ‘safe positions’ into the mechanism. A ‘safe’ position is self locking and the switch cannot be moved from a ‘safe’ position accidentally. Thus, until the handle has passed the final safe position the handle is biased towards a non-conducting position. This can be achieved using springs in the mechanism.

The handle typically incorporates a knob or pin, for example on the shaft of the handle, which is located in a channel in the casing surrounding the handle. By providing a channel of which at least one portion is parallel to the shaft of the handle and at least one portion follows the circumference of the shaft, the handle is constrained to move both axially and rotationally. Depending on the shape of the channel the handle can be required to undergo a variety of combinations of axial and rotational movement.

For further safety the handle can be connected to the mobile conductors in such a way that the mobile conductors also undergo rotational and axial movement when moving between the non-conducting and conducting positions. Thus, when the mobile conductors are in the non-conducting position they are displaced axially and are also out of alignment rotationally with the contacts.

The handle can also be provided with a mechanical screwlock for further safety. A screwlock can be fitted to be operable in the ‘on’ position or ‘off’ position or both. Once the handle is in position the screwlock is engaged and this prevents the handle from being moved unless the screwlock is undone first. This is useful to prevent accidental movement of the handle, for example due to shock or vibration.

The handle may be operated manually or it may be adapted to be operated remotely, for example by a motor.

This switch is particularly suited to use in vehicles where part or all of the vehicle is powered by a portable power source. The switch may be used with a high voltage power source or a power source which produces a high current. For example, the power source may produce a voltage of at least 10V, more preferably at least 100V, more preferably at least 200V, more preferably at least 400V, most preferably at least 500V. A high current power source may produce a current of at least 10 A, more preferably at least 100 A, more preferably at least 200 A, more preferably at least 400 A, most preferably at least 500 A. In a preferred embodiment of the invention, the power source is a battery. High conductivity copper conductors and contacts are particularly preferred for high current applications. It is also preferred to use low resistance mobile conductors to make the electrical connection, for example torsional spring conductors of high conductivity copper, preferably plated with gold.

The switch may also be used at low pressures, for example when used to power part of a vehicle that is used in space or in a low pressure situation. Switch configurations where the contacts are dead-faced, i.e. there is no line of sight path between contacts at opposite polarities, until the electrical connection is made are particularly suitable in such conditions. The conducting parts of the switch may also be covered with a layer of insulator at all points except where electrical contact is made. In addition, the use of two electrical connections can increase the distance between opposite poles when the connection is broken reducing the chance of voltage breakdown across the gap particularly in low pressure situations. Switches for low pressure or vacuum use are typically designed with swept back corners so as to minimise the possibility of arcing between the conductors.

The invention will now be described by way of example and with reference to the drawings filed herewith, in which:

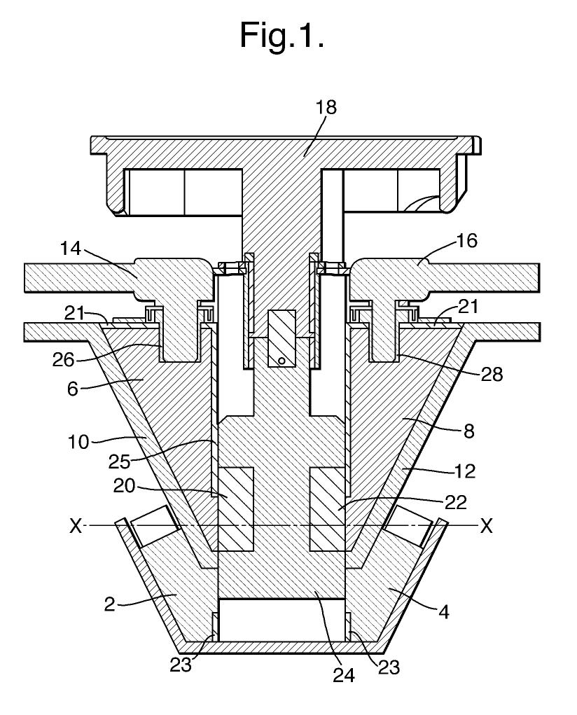

FIG. 1 shows a cross-sectional view through a switch of the present invention;

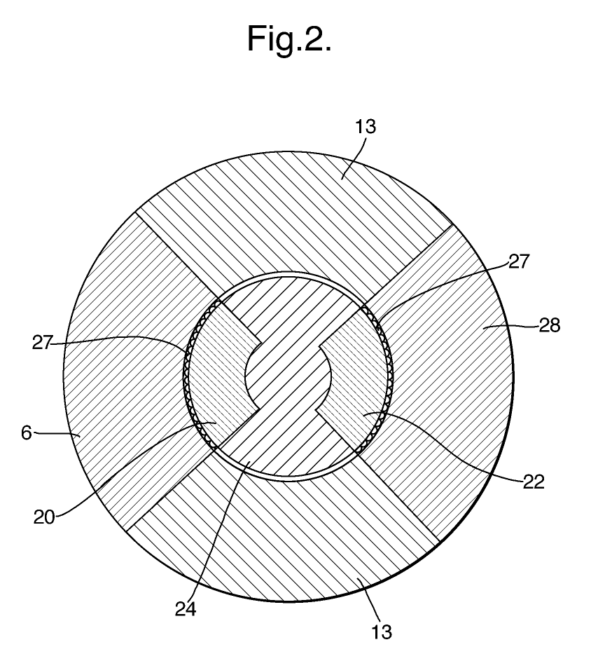

FIG. 2 shows a cross-sectional view of rod 24 and the adjacent conductors 6, 8 along the line X-X in FIG. 1; and

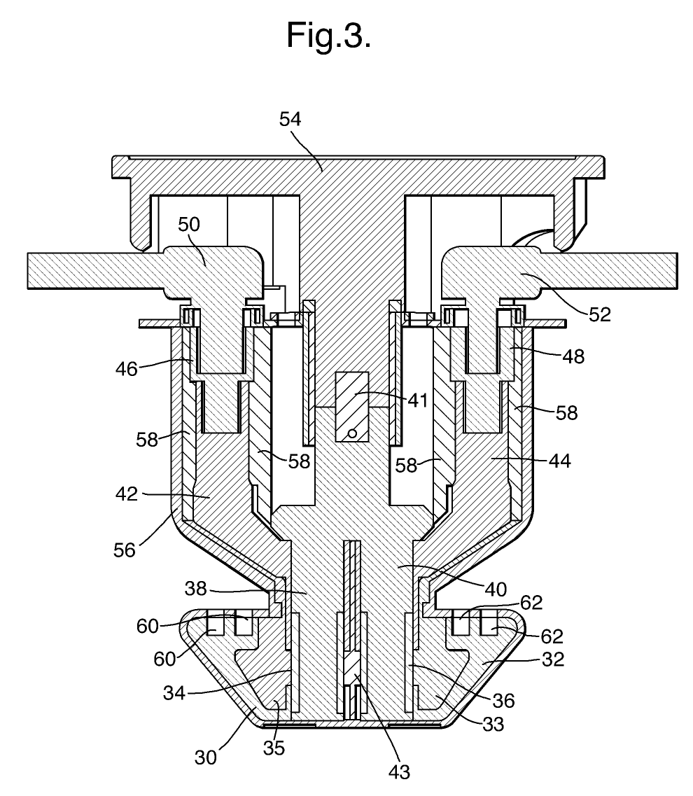

FIG. 3 shows a cross-sectional view through a switch of the present invention.

FIG. 1 shows a switch of the present invention which has power source contacts 2,4 and fixed electrical contacts 6,8. The fixed electrical contacts 6,8 incorporate sockets 26,28 into which are connected plugs 14,16 which connect to the rest of the electrical circuit. The sockets 26,28 and plugs 14,16 have different dimensions to prevent reverse connection of the switch from occurring. The power source contacts 2,4 and the fixed electrical contacts 6,8 are coated with an insulator 21,23,25 where no electrical connection to the contact is required.

Mobile contacts 20,22 are located on a rod 24 made of an insulating material. In FIG. 1 the mobile contacts 20,22 are shown in a non-conducting position. The rod 24 is connected to a handle 18 made of an insulating material. In use the handle 18 is rotated and then moved axially by the operator toward the power source contacts 2,4 and the mobile conductors 20, 22 move into a position where conductor 22 contacts the fixed contact 8 and the power source contact 4. Conductor 20 moves into an equivalent position where it is in contact with fixed electrical contact 6 and power source contact 2. FIG. 1 shows the handle after it has been rotated but before the axial movement. Once the mobile conductors reach the conducting position the handle 18 covers the plugs 14,16 and prevents them from being disconnected while the power is connected.

FIG. 2 shows a cross-section through the rod 24 and the adjacent conductors 6,8 along the line X-X in FIG. 1. Mobile conductors 20 and 22 form sections of the rod and are insulated from one another by insulators 24. Solid glass reinforced epoxy resin is a preferred material for the insulator. The mobile conductors 20,22 make electrical contact with the conductors 6,8 by means of the torsional springs 27 (shown schematically). The insulators 13 insulate the conductors 6,8 from one another.

In a further embodiment of the invention of FIG. 1 the mechanism connecting the handle 18 to the rod 24 is such that the rod 24 turns through 90° with the handle. Thus, in the initial non-conducting position the mobile conductors 20,22 are not in contact with the conductors 6,8. As the handle 18 is turned the mobile conductors 20,22 come into contact with the fixed electrical contacts 6,8. This is a further non-conducting position. Then, as the handle is used to move the rod 24 axially towards the power source contacts 2,4 the mobile conductors also come into contact with the power source contacts 2,4 and the electrical connection is made.

FIG. 3 shows a switch of the present invention which has power source contacts 30,32 and fixed electrical contacts 42,44. The power source contacts 30,32 are insulated from the fixed electrical contacts 42,44 by insulators 35,33. The power source contacts 30,32 are provided with sockets 60,62 for connection to the power source. Two sockets are provided on each contact in order to provide redundancy. This is particularly required for switches that are to be used in space. The fixed electrical contacts 42,44 are electrically connected to sockets 46,48 into which are connected plugs 50 and 52 which connect to the rest of the electrical circuit. The sockets 46,48 and plugs 50,52 have different dimensions to prevent reverse connection of the power source from occurring. The fixed electrical contacts 42,44 are surrounded by an insulator 58. In an alternative embodiment (not shown) the fixed electrical contacts are coated with a layer of insulator. The insulator prevents arcing within the switch.

The mobile contacts 34,36 are located on two rods 38,40 made of an insulating material. The rods 38,40 are isolated from one another by the solid insulator 43. In FIG. 3 the mobile contacts 34,36 are shown in a conducting position. The rods 38,40 are connected to a handle 54 made of an insulating material. In use the handle 54 is moved by the operator axially, that is vertically with respect to FIG. 3, and then rotated. When the handle has been raised sufficiently the electrical connection between the fixed contacts 42,44 and the power source contacts 30,32 is broken. The handle is connected to the rods 38,40 via a rotateable connection 41. This enables the handle 54 to be rotated relative to the rods 38,40. For example, the rotating connection may be configured so as only to allow rotation of the handle when the mobile conductors are in the non-conducting position thus only allowing access to the plugs 50,52 when the switch is ‘off’.

1. A switch comprising:
first and second fixed electrical contacts,
first and second power source contacts,
a handle, and
two mobile conductors moveable axially simultaneously between a non-conducting position and a conducting position wherein in the conducting position one conductor contacts the first fixed electrical contact and the first power source contact and the other conductor contacts the second fixed electrical contact and the second power source contact and wherein subjecting the handle to both rotational and axial movement causes the mobile conductors to move between the non-conducting position and the conducting position for activating said switch.

2. A switch according to claim 1 wherein said switch further comprises two rods and one mobile conductor is located on each rod.

3. A switch according to claim 1 wherein said mobile conductors comprise torsional springs.

4. A switch according to claim 1 wherein said handle covers said fixed electrical contacts when said mobile conductors are in the conducting position.

5. A switch according to claim 1 adapted for manual operation.

6. A multipolar switch comprising:
multiple fixed electrical contacts,
multiple power source contacts,
a handle, and
multiple mobile conductors moveable axially simultaneously between a non-conducting position and a conducting position wherein in the conducting position each mobile conductor contacts a fixed electrical contact and a power source contact and wherein subjecting the handle to both rotational and axial movement causes the mobile conductors to move between the non-conducting position and the conducting position, for activating said switch.

7. A power source comprising a switch according to claim 1.

8. A battery comprising a switch according to claim 1.

9. Use of a switch according to claim 1 in an electrical circuit.

10. Use of a switch according to claim 9 in vacuum.

11. Use of a power source according to claim 7 in an electrical circuit.

12. A power source comprising a switch according to claim 6.

13. A battery comprising a switch according to claim 6.

14. Use of a switch according to claim 6 in an electrical circuit.

15. Use of a switch according to claim 14 in vacuum.

16. Use of a power source according to claim 12 in an electrical circuit.
